(19) United States
(12) Patent Application Publication
(10) Pub. No.: US 2026/0307964 A1
(43) Pub. Date: Oct. 8, 2026

(54) HANDLING MACHINE WITH AN ENERGY STORAGE DEVICE POSITIONED UNDER THE DRIVERS CAB

(71) Applicant: MANITOU BF, ANCENIS (FR)

(72) Inventors: Pierre BERTRAND, ANCENIS (FR); Maurice BESSEAU, ANCENIS (FR); Xavier SCHELL, ANCENIS (FR); Valentin BREHIER, ANCENIS (FR)

(21) Appl. No.: 19/481,714

(22) PCT Filed: Mar. 20, 2024
(86) PCT No.: PCT/EP2024/057371

§ 371 Date: Nov. 5, 2025

(30) Foreign Application Priority Data
May 17, 2023 (FR) 2304887

(51) Int. Cl. B66F 9/075; B60K 1/00; B60K 1/02; B60K 1/04; B60K 15/03; B60K 15/063; B60K 15/07; B66F 9/065

(52) U.S. Cl. CPC B66F 9/07518; B60K 1/02; B60K 15/07; B66F 9/0655; B66F 9/07531; B66F 9/07572; B60K 2001/001; B60K 2001/0438; B60K 2015/03315; B60K 2015/0634; B60Y 2200/15; B60Y 2306/01; B60Y 2400/202

(57) ABSTRACT

The invention concerns a handling machine (1) including:
a chassis (2) having a median longitudinal axis (X);
a driver's cab (11) fixed to the chassis (2) on a first side of the chassis (2) relative to the median longitudinal axis (X) of the chassis (2);
a support device (20) configured to support an energy storage device (16, 19) and to fix it to the chassis (2) or to the driver's cab (11); the support device (20) including deformable links (22, 26, 33, 34) and a frame (21) into which the energy storage device (16, 19) is fixed.

### TECHNICAL FIELD

The invention relates to the field of handling machines including a chassis, a lifting arm and a driver's cab that is fixed to the chassis and positioned on a first lateral side of the chassis.

### TECHNICAL BACKGROUND

There is known from the document U.S. Pat. No. 6,688,481 a handling machine that includes a chassis, a telescopic arm that is mounted on and articulated to the chassis about a transverse axis and is mobile in a median longitudinal plane of the handling machine, and a driver's cab on one lateral side of the handling machine relative to the lifting arm. The handling machine includes an electric motor configured to propel it. The handling machine also includes a battery or a fuel cell system connected to the electric motor in order to supply it with electrical energy. The battery or the fuel cell system is disposed on a rear part of the chassis of the vehicle in order to form a counterweight.

Such a handling machine is not entirely satisfactory, in particular because the aforementioned disposition of the battery or the fuel cell system does not enable them to be effectively protected against impacts whereas the battery or the hydrogen tank of the fuel cell system is particularly sensitive to impacts, which are in particular liable to lead to fires or explosions.

### SUMMARY OF THE INVENTION

One idea behind the invention is to propose a handling machine offering increased safety.

In accordance with a first object the invention concerns a handling machine including:
a chassis having a median longitudinal axis;
a lifting arm mounted on and pivoting on the chassis;
a driver's cab that is fixed to the chassis on a first side of the chassis relative to the median longitudinal axis of the chassis;
an energy storage device housed in a compartment under the driver's cab;
a support device configured to support the energy storage device, the support device including deformable links and a frame inside which the energy storage device is fixed, the deformable links being configured to fix the frame to the chassis or to the driver's cab and having a stiffness for a first force applied to the support device, in particular to the frame, with a vertical component that is less than a stiffness of the frame for said first force so that the deformable links are deformed more than the frame if said first force is exerted.

Arranging the energy storage device in a compartment under the driver's cab therefore offers in particular excellent protection against dropped objects. Furthermore, thanks to the support device that prioritizes deformation of the deformable links over deformation of the frame, which is more rigid, the risks of destruction and/or explosion of the energy storage device that is fixed in the frame are lower, in particular if the handling machine overturns.

In one embodiment the deformable links are configured to fix the frame to the chassis and the support device includes an abutment element that is configured for the driver's cab to bear on it when said driver's cab is deformed by the effect of a deformation force that is exerted on said driver's cab with a horizontal component directed transversely outward. Such an abutment element enables control of the potential point of contact between the driver's cab and the support device in the event of overturning.

In one embodiment the abutment element projects upward from the frame in the direction of the driver's cab and is on an upper surface of the frame situated along an edge of the frame transversely opposite the chassis. By increasing the lever arm this enables even greater prioritization of deformation of the deformable links over that of the frame.

In one embodiment the deformable links have a working section corresponding to the application of the first force to the frame that has an area less than that of a working section of the frame.

In one embodiment the deformable links have a working section with a moment of inertia about an axis parallel to the median longitudinal axis that is less than a moment of inertia of the working section of the frame about said axis parallel to the median longitudinal axis.

In an alternative or complementary embodiment the frame is made of a first metal having a first modulus of elasticity and the deformable links include a second material having a second modulus of elasticity lower than the first modulus of elasticity.

In one embodiment the second material is an elastomer such as rubber.

In one embodiment the deformable links have a stiffness corresponding to the application of the first force to the frame greater than a stiffness of the deformable links corresponding to the application of a force to the frame horizontally and parallel to the median longitudinal axis. This enables the deformable links to be deformed less if the handling machine is subjected to front end impacts than if it overturns and the driver's cab is consequently deformed until it comes to bear against the support device.

To this end in one embodiment the deformable links and more particularly their working section have a particular moment of inertia with respect to a horizontal axis parallel to the median longitudinal axis that is greater than a particular moment of inertia of the working sections of said deformable links relative to a vertical axis.

In one embodiment the energy storage device is a pressurized gas storage tank or an electrical energy storage device.

In one embodiment the energy storage device is a pressurized gas storage tank adapted to store hydrogen at a maximal pressure between 300 bar and 700 bar.

In one embodiment the deformable links fix the frame to the chassis and said deformable links have a stiffness in bending corresponding to the application of the first force less than a stiffness in bending of the frame for said first force.

In one embodiment the chassis includes a first rail and a second rail that extend parallel to the median longitudinal axis on respective opposite sides of said median longitudinal axis, the first rail being on the first side of the chassis relative to the median longitudinal axis, the driver's cab and the deformable links being fixed to said first rail.

In one embodiment the support device includes at least two deformable links distributed longitudinally along the longitudinal chassis.

In one embodiment the deformable links fix the frame to the driver's cab, in particular to its floor, and said deformable links have a stiffness in compression corresponding to the application of the first force that is less than a stiffness in compression of the frame for said first force.

### BRIEF DESCRIPTION OF THE FIGURES

The invention will be better understood and other aims, details, features and advantages thereof will become more clearly apparent in the course of the following description of particular embodiments of the invention given by way of non-limiting illustration only with reference to the appended drawings.

FIG. 1 is a schematic side view of a handling machine including a compartment under the driver's cab housing an energy storage device.

FIG. 2 is a schematic view from above of the handling machine from FIG. 1.

FIG. 3 is a partial rear view of a first embodiment of a handling machine showing in particular the front wall of the driver's cab, one of the rails of the chassis, the energy storage device and the support device, which is configured to support the energy storage device.

FIG. 4 is a view similar to that of FIG. 2 depicting deformations of the chassis and of the driver's cab liable to be produced in the event of the handling machine overturning.

FIG. 5 is a view similar to that of FIGS. 3 and 4 depicting the deformations of the support device liable to occur in the event of deformations of the chassis and the driver's cab as schematically depicted in FIG. 4.

FIG. 6 is a schematic view of a support device and how it is fixed to the first embodiment of the handling machine.

FIG. 7 is a schematic view of a support device and how it is fixed a variant of the first embodiment of the handling machine from FIG. 5.

FIG. 8 is a schematic view of a second embodiment of the support device and how it is fixed to the handling machine.

FIG. 9 is a schematic view of the frame of the support device in one embodiment.

FIG. 10 is a schematic view depicting the geometry of a deformable link in one embodiment.

FIG. 11 is a schematic depicting a safety device configured in particular to control a shut-off valve associated with a hydrogen tank in one embodiment.

### DESCRIPTION OF EMBODIMENTS

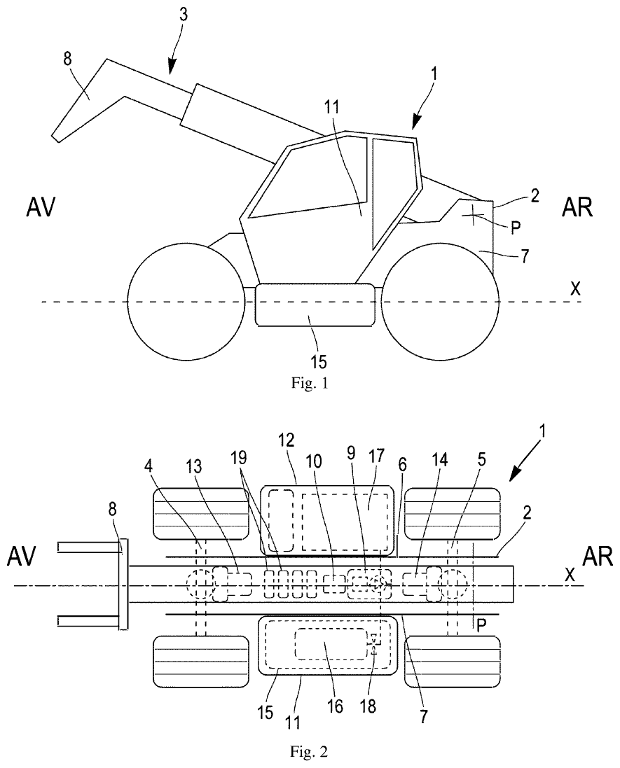

By convention the “longitudinal” direction of the handling machine corresponds to its front-to-rear orientation. Furthermore the terms “rear” and “front” respectively designated AR and AV in FIGS. 1 and 2 are used to define the relative position of one element with respect to another in the longitudinal direction. The median longitudinal axis designated X in the figures is an axis oriented in the longitudinal direction and passing through the middle of the front and rear axles of the handling machine. The “transverse” direction is perpendicular to the longitudinal direction.

A first embodiment of a handling machine 1 is described with reference to FIGS. 1 and 2. The handling machine 1 includes a chassis 2 and a load-handling device, here a lifting arm 3, mounted on and mobile on the chassis 2.

The chassis 2 is mobile. To this end the handling machine 1 includes two axles, namely a front axle 4 and a rear axle 5, each of which is mounted on the chassis 2 along a transverse axis and each of which carries two wheels, one on the left and the other on the right.

In the embodiment represented the chassis 2 includes two rails 6, 7 seen in FIG. 2. The rails 6, 7 are globally plane parallel metal parts that extend parallel to the median longitudinal axis X on respective opposite sides of the median longitudinal axis X.

The lifting arm 3 extends in a longitudinal plane that is preferably a median plane, that is to say a plane that includes the median longitudinal axis X. The lifting arm 3 is between and articulated to the two rails 6, 7 so as to be able to pivot relative to the two rails 6, 7 about a transverse pivot axis P. The lifting arm 3 can be produced in various ways, in particular in the form of a plurality of telescopic sections. In this case the handling machine 1 can in particular be a telescopic lift truck. Alternatively the lifting arm 3 takes the form of an arm of fixed length. An end of the lifting arm 3 opposite the pivot axis P can carry a working tool 8 or a modular tool carrier able to receive working tools 8 of several types. By working tool 8 is meant for example a pair of forks, a bucket, a winch, lifting tongs, etc.

The handling machine 1 includes one or more linear actuators, not represented, such as hydraulic cylinders, each of which is mounted on and articulated on the one hand on the lifting arm 3 and on the other hand on the chassis 2 of the handling machine 1, which enables the lifting arm 3 to be pivoted relative to the chassis 2. The hydraulic cylinders are connected to a hydraulic circuit including a hydraulic pump 9 seen in FIG. 2. In the embodiment represented the hydraulic pump 9 is driven by a motor such as an electric motor 10. The hydraulic pump 9 and the electric motor 10 are here housed in the chassis 2, between the two rails 6, 7, but can be positioned at other locations.

Furthermore the handling machine 1 includes a driver's cab 11 in which a driver sits and that in particular includes a seat, not represented, and equipment for controlling the handling machine 1. The driver's cab 11 is positioned on a first side of the median longitudinal axis X, on the left-hand side in the embodiment represented, and between the front axle 4 and the rear axle 5. The driver's cab 11 is fixed to the chassis 2 and more particularly to one of the rails 7 of the latter. The handling machine 1 also includes a compartment 15 housing an energy storage device described below.

The handling machine 1 further includes a tank 12 seen in FIG. 2 positioned on the opposite side of the median longitudinal axis X of the handling machine 1 to the driver's cab 11. The tank 12 is fixed to the other of the rails 6. The tank 12 and the driver's cab 11 are therefore on respective opposite sides of the pair of rails 6, 7.

The handling machine 1 further includes at least one motor such as an electric motor 13, 14 for example that is configured to move the handling machine 1. In the embodiment represented in FIG. 2 the handling machine 1 includes two electric motors 13, 14 for moving it. Each electric motor 13, 14 is coupled to the front axle 4 or the rear axle 5 via a transmission device.

At least one energy storage device is housed in the compartment 15 under the driver's cab 11 and supported by a support device described below. In the embodiment represented the energy storage device that is housed in the aforementioned compartment 15 includes a tank 16 intended to store hydrogen that is connected to a fuel cell 17.

The tank 16 is for example adapted to store hydrogen in the gas state at a maximal pressure between 300 bar and 700 bar, for example of the order of 350 bar. In another embodiment the tank 16 is adapted to store hydrogen in the solid state in the form of metal hydrides. The tank 16 is associated with a shut-off valve 18 that in the closed state prevents hydrogen from escaping from the tank 16.

The tank 16 is connected to the fuel cell 17 by a circuit that in particular includes a pressure regulator, not shown, for reducing the pressure in order to feed the fuel cell 17 with hydrogen at a pressure compatible with its operation, that is to say lower than that at which it is stored in the tank 16. In a manner that is known in itself the fuel cell 17 is the seat of an oxidation-reduction reaction that transforms into electricity, water and heat hydrogen coming from the tank and oxygen from the air fed by the compressor.

The handling machine 1 also includes an electrical energy storage device comprising one or more batteries 19 and/or one or more supercapacitors. The terminals of the batteries 19 and/or the supercapacitors are connected to the electric motors 10, 13, 14 in parallel with the fuel cell 17.

The handling machine 1 further includes power electronics, not shown, that include in particular a DC/DC voltage converter that is connected on one side to the fuel cell 17 and on the other side to the electric motors 10, 13, 14 and to the electrical energy storage device, here the batteries 19. The DC/DC voltage converter converts the voltage delivered by the fuel cell 17 to a voltage required by the electric motors 10, 13, 14 and the batteries 19. Control means, also not shown, are configured to control the fuel cell 17, the electric motors 10, 13, 14 and the DC/DC voltage converter as a function of control signals delivered by controls of the handling machine such as in particular an accelerator pedal and/or a control joystick. In FIG. 2 the fuel cell 17 is housed in the tank 12.

In another embodiment, not shown, the motor that is configured to move the handling machine is not an electric motor but a hydrogen internal combustion engine (HICE). The hydrogen internal combustion engine can in this case take the place of the fuel cell 17 of the embodiment from FIGS. 1 and 2 in the tank 12.

Furthermore, in other embodiments that are not shown the energy storage device that is housed in the compartment 15 under the driver's cab 11 is a device that stores electrical energy and typically includes one or more batteries and/or one or more supercapacitors. In this case the handling machine 1 need not include tanks 16 for storing hydrogen and a fuel cell 17 intended to charge the batteries and/or the supercapacitors, the batteries and/or the supercapacitors then being charged via charging terminals. Alternatively the machine can equally include one or more tanks 16 intended to store hydrogen positioned at one or more locations of the handling machine 1 different from the compartment 15, for example in the chassis 2 and/or in the tank 12.

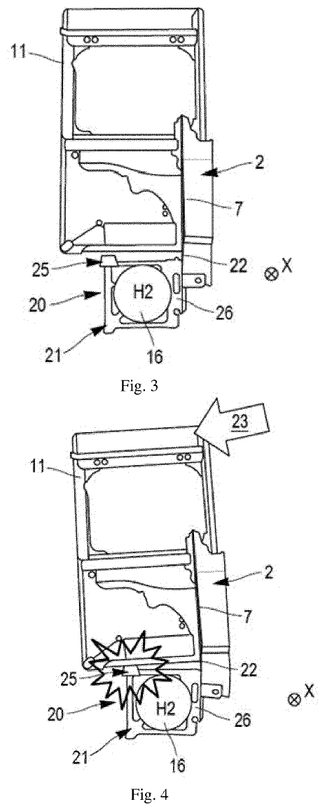

Described below with reference to FIGS. 3 to 6 is a support device 20 that is configured to support the energy storage device housed in the compartment 15 under the driver's cab 11, here a tank 16. In order to enable the energy storage device and its support device to be seen the walls of the compartment 15 are not represented.

As represented in FIGS. 3 to 6 the support device 20 includes a frame 21 inside which the tank 16 is fixed. The frame 21 consists of an assembly of rigid parts constituting an armature around the energy storage device. It includes for example a plurality of metal beams extending parallel to the longitudinal direction of the handling machine 1 and connected to one another by metal beams extending transversely.

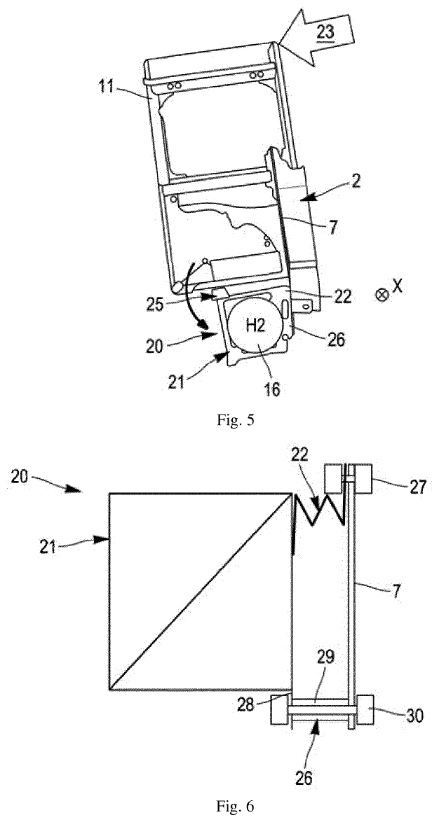

The support device 20 also includes deformable links 22, 26 that fix the frame 21 to the chassis 2 of the handling machine 1 and more particularly to the rail 7 to which the driver's cab 11 is fixed. As represented in FIGS. 4 and 5 if the driver's cab 11 and/or the chassis 2 are deformed so that the driver's cab 11 comes into contact with the frame 21 of the support device 20 and exerts on the latter a force having an upwardly directed vertical component the deformations of the support device 20 are prioritized at the level of the deformable links 22, 26, which makes it possible to prevent or at least to limit the deformation of the frame 21 and the energy storage device housed in said frame 21. Such deformations are in particular liable to occur if the handling machine 1 overturns and the interior side, here the right-hand side, of the driver's cab 11 comes into contact with the ground with the result that the later exerts on the driver's cab 11 an outwardly directed reaction force schematically represented by the arrow 23 in FIGS. 5 and 6. Thus prioritizing deformations of the deformable links 22, 26 over deformations of the frame 21 reduces the risks of destruction and explosion of the energy storage device.

In the embodiment of FIGS. 3 to 5 if the driver's cab 11 moves toward and comes into contact with the frame 21 it exerts on the frame 21 a force having a vertical component. The deformable links 22, 26 are then loaded in bending by a force exerted on the frame 21 having an upwardly directed vertical component. In order for deformation of the deformable links 22, 26 to be prioritized over that of the frame 21 the stiffness in bending of the deformable links 20 for a bending force applied vertically to the frame 21 is then lower than the stiffness in bending of the frame 21.

In one embodiment the frame 21 and likewise the deformable links 22, 26 are made of steel, for example either S235 or S500 steel that respectively have an elastic limit of 235 MPa or 500 MPa and a Young's modulus of the order of 210 GPa. In such an embodiment it is the geometry of the deformable links 22, 26 that is adapted in order to confer on them a stiffness in bending for the aforementioned force exerted on the frame 21 less than that of the frame 21. To this end the working section of the deformable links 22, 26, that is to say the section in which the deformation is the greatest for a force having the aforementioned characteristics, has an area that is less than the corresponding working section of the frame 21. In particular the working section of the deformable links 22, 26 has a moment of inertia about an axis parallel to the median longitudinal axis X that is less than the moment of inertia of the working section of the frame 21 about that axis.

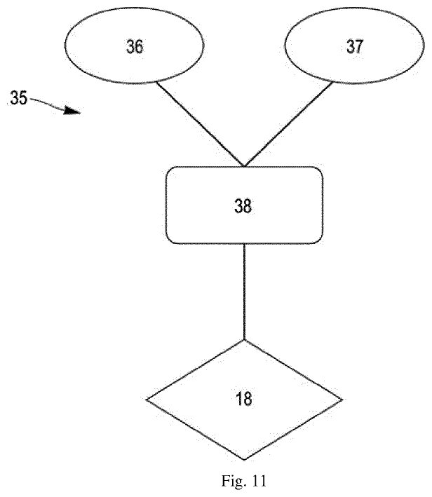

FIG. 10 depicts the profile in a transverse plane of a deformable link 22 in one embodiment. In this embodiment the section of the deformable link 22 as seen on a longitudinal section plane is not constant and varies transversely. It is therefore seen that the deformable link 22 has sections 24 in a longitudinal plane parallel to the median longitudinal axis X the area of which is reduced relative to the other sections. These reduced area sections 24 therefore form the working sections of the deformable link 22. Such a geometry of the deformable link 22 therefore enables stress concentrations to be localized in these sections 24 and prioritization of deformation in bending of the deformable link 22.

Returning to FIGS. 3 to 5 it is seen that in one advantageous embodiment the support device 20 includes one or more abutment elements 25 configured for the driver's cab 11 to bear on them when it moves toward the support device 20 because of the effect of the force schematically represented by the arrow 23. This abutment element 25 projects upward from the frame 21 toward the driver's cab 11 and is positioned on an upper surface of the frame 21 that is preferably situated along an edge of the frame 21 transversely opposite the chassis 2. This enables control of the point of contact between the driver's cab 11 and the support device 20. Furthermore, by positioning this abutment element 25 along the edge of the frame 21 opposite the chassis 2 the lever arm between the point of application of the force and the deformable links 22, 26 enables further prioritization of deformation of the deformable links 22, 26 over that of the frame 21.

In other alternative or complementary embodiments the deformable links 22, 26 include at least one material having a modulus of elasticity less than that of the metal from which the frame 21 is made. This material is for example an elastomer such as rubber.

FIG. 6 schematically represents a support device 20 and how it is fixed to the handling machine 1 in a first embodiment. It is seen here that the frame 21 is fixed to the rail 7 by deformable links 22, 26 that have different geometries and characteristics. The deformable link 22 fixed to the upper part of the frame 21 is for example welded to the frame 21 and fixed to the rail 7 by a fixing member 27 such as a nut and bolt assembly. In this embodiment the deformable link 26 that is fixed to the lower part of the frame 21 includes a fixing lug 28 that projects downward from the frame 21, a spacer 29 between the fixing lug 28 and the rail 7, and a fixing member 30 such as an assembly comprising a nut and a bolt that passes through an orifice in the fixing lug 28, an orifice in the spacer 29 and an orifice in the rail 7 in order to fasten the fixing lug 28, the spacer 29 and the rail 7 rigidly together. In such a deformable link 26 the deformation is localized at the level of the fixing lug 28 which has a section having an area less than that of the frame 21 and therefore forms the working section of the deformable link 26.

Note that the support device 20 advantageously includes a plurality of deformable links 22, 26 that are distributed longitudinally along the frame 21. Furthermore, in one embodiment it is particularly advantageous for the deformable links 22, 26 to have a preferred deformation direction so that they are deformed more if a force is applied vertically to the frame 21 than if a force is applied horizontally, which is in particular the case of impacts from the front or the side. To this end the deformable links 22, 26 have a stiffness in bending for a force applied horizontally to the frame 21 parallel to the median longitudinal axis X that is greater than the stiffness in bending of the deformable links 22, 26 for a force applied vertically to the frame 21. The deformable links must advantageously further be able to be deformed without breaking in the event of an impact having an energy less than or equal to 11.6 kJ.

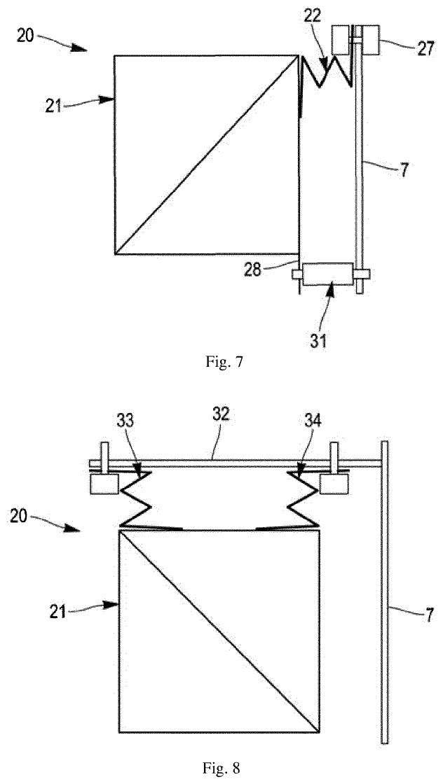

FIG. 7 represents a support device 20 and how it is fixed to a second embodiment of the handling machine 1. This second embodiment differs from that described hereinabove with reference to FIG. 6 only in the structure of the deformable link 26 that is fixed to the lower part of the frame 21. In fact in this embodiment the spacer 31 between the fixing lug 28 and the rail 7 is riveted on the one hand to the fixing lug 28 and on the other hand to the rail 7.

FIG. 8 schematically depicts a support device 20 and how it is fixed in a third embodiment. This embodiment differs from the embodiments described hereinabove in that the support device 20 is fixed not to the rail but to the floor 32 of the driver's cab 11. In such an embodiment the deformable links 33, 34 are then loaded in compression if the driver's cab 11 and/or the chassis 2 is/are deformed so that the driver's cab 11 moves toward the support device 20. The deformable links 33, 34 therefore have a stiffness in compression less than that of the frame 21 for a force applied that has a downwardly oriented vertical component.

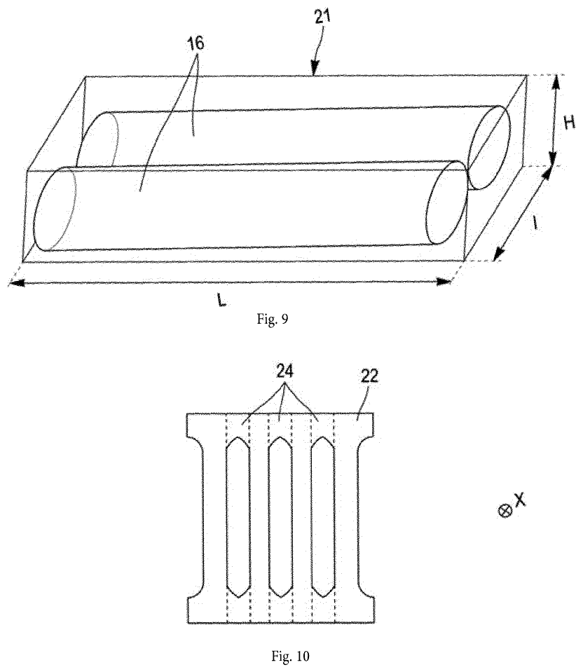

Referring to FIG. 9 there are seen the dimensions of a frame 21 of a support 20 in accordance with one embodiment. In this embodiment the energy storage device fixed inside the frame includes two hydrogen storage tanks 16. In other variants the energy storage device can include only one tank 16 or more than two tanks. Each tank 16 has a circular cylindrical shape around an axis that is advantageously parallel to the median longitudinal axis X. The frame has for example a length L of approximately 1.5 m, a width l of approximately 0.5 m and a height h of approximately 0.4 m.

Furthermore, in one advantageous embodiment the handling machine 1 includes a safety device 35 depicted schematically in FIG. 11. This safety device 35 includes one or more accelerometers 36, that is to say one or more sensors delivering a signal representing the acceleration of the handling machine 1, and one or more angle sensors 37, that is to say one or more sensors delivering a signal representing an angle of the handling machine 1 relative to a horizontal plane. The accelerometer(s) 36 and the angle sensor(s) 37 are connected to a control unit 38 that is also connected to the shut-off valve 18 associated with each tank 16 and configured to control it. The control unit 38 is configured to compare the signal representing the acceleration of the handling machine 1 delivered by the accelerometer or accelerometers 38 to an acceleration threshold value and thus to detect an impact if the absolute value of the acceleration detected is greater than an acceleration threshold value. The control unit 38 is also configured to compare the signal representing the angle of the handling machine 1 relative to a horizontal plane delivered by the angle sensor or sensors 37 to an angle threshold and thus to detect overturning if the value of the angle detected is greater than the angle threshold.

Furthermore, the control unit 38 is also configured to control closing of the shut-off valve 18 associated with the tank 16 in response to the detection of an impact or overturning. This makes it possible to isolate the hydrogen circuit and thus to limit the risks of fire or explosion in the event of impacts and/or overturning of the handling machine 1.

In an alternative or complementary variant the control unit 38 is also configured to disconnect a high-voltage circuit of the handling machine 1 by means of a relay.

The control unit 38 can also be configured to transmit an alert signal to the driver informing them that an impact and/or overturning has/have been detected and/or that the machine has been made safe by closing the shut-off valve and disconnecting the high-voltage circuit. The alert signal is for example a message that is displayed on a dashboard of the handling machine 1.

Although the invention has been described with reference to particular embodiments it is obvious that it is in no way limited to them and that it includes all technical equivalents of the means described and combinations thereof if they fall within the scope of the invention.

Use of the verb “to include” or “to comprise” and conjugate forms thereof does not exclude the presence of elements or steps other than those stated in a claim.

In the claims any reference sign between parentheses should not be interpreted as a limitation of the claim.

1. A handling machine (1) including:
a chassis (2) having a median longitudinal axis (X);
a lifting arm mounted on and pivoting on the chassis (2);
a driver's cab (11) fixed to the chassis (2) on a first side of the chassis (2) relative to the median longitudinal axis (X) of the chassis (2);
an energy storage device (16, 19) housed in a compartment (15) under the driver's cab (11);
a support device (20) configured to support the energy storage device (16, 19), the support device (20) including deformable links (22, 26, 33, 34) and a frame (21) inside which the energy storage device (16, 19) is fixed, the deformable links (22, 26, 33, 34) being configured to fix the frame (21) to the chassis (2) or to the driver's cab (11) and having a stiffness for a first force applied to the support device (20) with a vertical component that is less than a stiffness of the frame (21) for said first force so that the deformable links (22, 26, 33, 34) are deformed more than the frame (21) if said first force is exerted.

2. The handling machine (1) as claimed in claim 1 in which the deformable links (22, 26, 33, 34) are configured to fix the frame (21) to the chassis (2) and the support device (20) includes an abutment element (25) that is configured for the driver's cab (11) to bear on it when said driver's cab (11) is deformed by the effect of a deformation force that is exerted on said driver's cab (11) with a horizontal component directed transversely outward, said abutment element (25) projecting upward from the frame (21) toward the driver's cab (11) and being positioned on an upper surface of the frame (21) situated along an edge of the frame (21) transversely opposite the chassis (2).

3. The handling machine (1) as claimed in claim 1 or 2 in which the deformable links (22, 26, 33, 34) have a working section corresponding to the application of the first force to the frame (21) that has an area less than that of a working section of the frame (21).

4. The handling machine (1) as claimed in any one of claims 1 to 3 in which the frame (21) is made of a first metal having a first modulus of elasticity and the deformable links (22, 26, 33, 34) include a second material having a second modulus of elasticity lower than the first modulus of elasticity.

5. The handling machine (1) as claimed in any one of claims 1 to 4 in which the deformable links (22, 26, 33, 34) have a stiffness corresponding to the application of the first force to the frame (21) greater than a stiffness of the deformable links (22, 26, 33, 34) corresponding to the application of a force to the frame (21) horizontally and parallel to the median longitudinal axis (X).

6. The handling machine (1) as claimed in any one of claims 1 to 5 in which the energy storage device is a pressurized gas storage tank (16) or an electrical energy storage device.

7. The handling machine (1) as claimed in claim 6 in which the energy storage device is a pressurized gas storage tank adapted to store hydrogen at a maximal pressure between 300 bar and 700 bar.

8. The handling machine as claimed in any one of claims 1 to 7 in which the deformable links (22, 26) fix the frame (21) to the chassis (2) and said deformable links (22, 26) have a stiffness in bending corresponding to the application of the first force less than a stiffness in bending of the frame (21) for said first force.

9. The handling machine (1) as claimed in claim 8 in which the chassis (2) includes a first rail (7) and a second rail (8) that extend parallel to the median longitudinal axis (X) on respective opposite sides of said median longitudinal axis (X), the first rail (7) being on a first side of the chassis (2) relative to the median longitudinal axis (X), the driver's cab (11) and the deformable links (22, 26) being fixed to said first rail (7).

10. The handling machine (1) as claimed in claim 9 in which the support device (20) includes at least two deformable links (22, 26, 33, 34) distributed longitudinally along the longitudinal chassis (2).

11. The handling machine as claimed in any one of claims 1 to 7 in which the deformable links (22, 26) fix the frame (21) to the driver's cab (11) and said deformable links (33, 34) have a stiffness in compression corresponding to the application of the first force that is less than a stiffness in compression of the frame (21) for said first force.
